(19) United States
(12) Patent Application Publication
(10) Pub. No.: US 2026/0217940 A1
(43) Pub. Date: Jul. 30, 2026

(54) Method Of Depolymerizing A Polymer Into Monomer And Use Of A Salt In Such A Method

(71) Applicant: Ioniqa Solutions B.V., Eindhoven (NL)

(72) Inventors: Egor Vasilyevich FUFACHEV, Eindhoven (NL); Joost Robert WOLTERS, Eindhoven (NL); André Banier DE HAAN, Eindhoven (NL)

(73) Assignee: Ioniqa Solutions B.V., Eindhoven (NL)

(21) Appl. No.: 19/143,808

(22) PCT Filed: Dec. 19, 2023
(86) PCT No.: PCT/NL2023/050669

§ 371 Date: Jun. 26, 2025

(30) Foreign Application Priority Data
Dec. 29, 2022 (NL) 2033867

(51) Int. Cl. C08J 11/16; C08J 11/18; C08K 3/26; C08K 3/30; C08K 5/098

(52) U.S. Cl. CPC C08J 11/16; C08J 11/18; C08K 3/26; C08K 3/30; C08K 5/098; C08J 2367/03; C08K 2003/262; C08K 2003/3045

(57) ABSTRACT

A method for obtaining a monomer by degrading a polymer, the polymer being a homo or copolymer of the monomer is described. The method comprising the steps of providing the polymer and a solvent as a reaction mixture in a reactor, wherein the solvent is a reactant capable of reacting with the polymer to degrade the polymer into oligomers and at least one monomer; providing a reusable catalyst being capable of degrading the polymer into oligomers and at least one monomer; degrading the polymer in the reaction mixture at reaction conditions using the catalyst to form a monomer; and recovering the catalyst from the reaction mixture; wherein the method further comprises the addition of a salt to the reaction mixture in at least one of the method steps, wherein the salt has at least one multivalent monoatomic or polyatomic anion. The present invention furthermore relates to the use of a salt as a recovery enhancing-agent and/or a co-catalyst for a catalyst in catalytic degradation of a polymer in a reaction mixture at reaction conditions.

### FIELD OF INVENTION

The invention relates to a method of depolymerizing a polymer into monomer using a reactive solvent for degrading the polymer and a reusable catalyst. The reusable catalyst catalyzes the degradation reaction of the polymer. In the method, a relatively large amount of the reusable catalyst applied may be recovered and put to use again. The invention also relates to the use of a salt as a recovery-enhancing agent and/or as a co-catalyst for a catalyst in catalytic depolymerization reactions that use the catalyst.

### BACKGROUND ART

There is a growing awareness that the huge amounts of polymers used nowadays for a variety of purposes should be recycled in order to prevent large amounts of polymer waste. Incineration is one possibility but undesirable for obvious reasons. Mechanical shredding and milling of used polymers may be another solution to the problem of accumulating polymer waste. The properties of such mechanically recycled polymers are degraded and they frequently end up as low-grade filler for other materials. In circular (chemical) recycling, the waste polymer is depolymerized into its repeating units, such as the monomers from which the polymer is made. Depolymerization methods may also yield dimers and oligomers, such as trimers and tetramers. The monomers, and optionally the oligomers, resulting from the degradation reaction may be used again in making a new polymer. Circular recycling therefore appears to be the method of choice.

In recycling, assuring a consistent and continuous source of waste polymer, such as bottles and textiles for instance, in a required amount is important. Also, impurities in the waste material that may for instance comprise materials other than the waste polymer, such as metals, other polymers, colorants, and the like may need to be separated from the waste polymer to be chemically recycled before depolymerization. Yet, even when separation of impurities from the waste polymer has been solved satisfactorily, the depolymerization of the polymer into monomers and oligomers has proven to be difficult. Many known methods are not selective enough or are deficient in terms of insufficient conversion (rates). Sufficient and relatively fast conversion of the polymer to the desired monomers and oligomers is desirable, while at the same time minimizing production of waste in terms of side products. In other words, a relatively high yield (selectivity times conversion) and rate of conversion is a desirable goal in depolymerizing a polymer into monomers.

Catalysts are often used for synthesis of polymers, but less for depolymerizing waste polymers. Catalytic activity may be sensitive to contaminants that are typically present in such waste polymers. As a result, catalysts that are used in depolymerization methods may need regular replacement or have to be relatively insensitive to contaminants. Particularly in the latter case, being able to recover and reuse the catalyst is an important aim. To catalyze the degradation (depolymerization) reaction and increase yield, either heterogeneous or homogeneous catalysts may be used. When using a heterogeneous catalyst, selectivity and conversion may be less than with homogeneous catalysts, and the amount of available catalysts to choose from is rather limited. Homogeneous catalysts however tend to be less recoverable. This may lead to contamination of the reaction products, which is less desirable.

A catalyst is typically provided in a reactive solvent that is capable of reacting with the polymer to degrade the polymer into its monomers and oligomers. Since catalysts may be quite expensive, it would be desirable to be able to recover a relatively large amount of catalyst after having degraded a polymer in the reaction mixture comprising the polymer, the reactive solvent and the catalyst. Such recovered catalyst could then be reused a second time and preferably many more times.

Specialized reusable catalysts for catalyzing depolymerization reactions do exist, such as the one described in WO 2016/105200 A1 or in U.S. Pat. No. 10,316,163 B2 for instance. The catalyst disclosed therein relates to a catalyst complex comprising three distinguishable elements: a nanoparticle, a bridging moiety attached to the nanoparticle, for instance by but not limited to a covalent bond, and a catalyst entity attached to the bridging moiety, for instance by, but not limited to, a covalent bond. The catalyst has been shown to be highly selective and to produce relatively high yield in depolymerization. The nanoparticle is preferably of a magnetic nature or may be magnetized to a sufficient extent under relatively modest magnetic fields. The use of magnetic nanoparticles improves recoverability of the catalyst, for instance by magnetic attraction after use.

Although the above exemplified reusable catalyst is recoverable to a satisfactory extend, being able to recover an increased amount of the exemplified and other reusable catalysts while substantially retaining the catalyzing activity of the recovered catalyst remains an important goal. A small waste of catalyst could be acceptable, for instance in the order of a few percent or less, such as less than 15 wt. %, more preferably less than 10 wt. %, even more preferably less than 8 wt. %, and even more preferably less than 5 wt. % of the catalyst. A substantially complete recovery of the catalyst however is most preferred.

Lopez-Fonseca R. et al., “Chemical recycling of post-consumer PET wastes by glycolysis in the presence of metal salts”, Polymer Degradation and Stability, Barking, GB, part 95, nr. 6, Mar. 16, 2010, XP027035680, ISSN 0141-3910, discloses metal salt catalysts that may be used in the depolymerization of PET, such as sodium carbonate, sodium bicarbonate, sodium sulphate, potassium sulphate, and zinc acetate.

Given the above, there is a need for a method of depolymerizing a polymer into monomer, wherein a substantial amount of the reusable catalyst used in the depolymerization reaction may be recovered and reused. There is a further need to increase the conversion rate of the depolymerization reaction and its yield.

### SUMMARY

A first aspect of the invention provides a method of depolymerizing a polymer into monomer, the polymer being a homo or copolymer of the monomer, the method comprising the steps of
a) providing the polymer and a solvent as a reaction mixture in a reactor, wherein the solvent is a reactant capable of reacting with the polymer to degrade the polymer into oligomers and at least one monomer;
b) providing a reusable catalyst being capable of degrading the polymer into the oligomers and the at least one monomer; and
c) degrading the polymer in the reaction mixture at reaction conditions using the catalyst to form the at least one monomer; and
d) recovering the catalyst from the reaction mixture;
   wherein the method further comprises the addition of a salt to the reaction mixture in at least one of the method steps a) to d), wherein the salt has at least one multivalent monoatomic or polyatomic anion.

According to a second aspect of the invention, a salt is provided for use as a recovery-enhancing agent and/or a co-catalyst for a reusable catalyst in catalytic degradation of a polymer in a reaction mixture at reaction conditions.

### DETAILED DESCRIPTION OF THE INVENTION

Unless otherwise defined, all technical and scientific terms used herein have the same meaning as commonly understood by one of ordinary skill in the art which this invention belongs to. The terminology used in the description of the invention herein is for the purpose of describing particular embodiments only and is not intended to be limiting of the invention.

The present invention relates to a method for obtaining a monomer by degrading a polymer, the polymer being a homo or copolymer of the monomer. A reusable catalyst being capable of degrading the polymer into oligomers and at least one monomer is used thereto. To recover the catalyst more easily and to a higher extent, at least one salt having at least one multivalent monoatomic or polyatomic anion is added to the reaction mixture in at least one of the reaction steps a) to d). It has further been established that the salt may improve the catalytic degrading of the polymer into smaller molecules when added to the reaction mixture in or before step c). Indeed, the salt as claimed may be instrumental in improving conversion rate and selectivity.

As used herein, the terms ‘substantially’, ‘essentially’, ‘consist(ing) essentially of, ‘essentially all’ and equivalents thereof have, unless noted otherwise, in relation to a composition or a method step the usual meaning that deviations in the composition or the method step may occur, but only to such an extent that the essential characteristics and effects of the composition or the method step are not materially affected by such deviations.

As further used herein, the terms ‘depolymerizing’, ‘depolymerization’, ‘degrading’ and ‘degradation’ have, unless noted otherwise, the same meaning of cutting the polymer molecules into molecules of smaller lengths to finally obtain monomers and oligomers, such as dimers, trimers and tetramers for instance.

As further used herein, the term ‘reusable catalyst’ in the context of the present invention denotes a catalyst that may be recovered from the reaction mixture after having degraded the polymer and reused in degrading the polymer with an acceptable yield a second time, more preferably 5 times or more, even more preferably 10 times or more, even more preferably 20 times or more, even more preferably 30 times or more, even more preferably 40 times or more, even more preferably 50 times or more, all with an acceptable yield. An upper limit may be set at any number of times between 100 and 500 times. An acceptable yield is a yield above 50%. A preferred reusable catalyst is a heterogeneous catalyst.

As further used herein, the term ‘amount’ or ‘amount relative to another amount’ always refers to a weight amount or weight percentage, unless noted otherwise.

As further used herein, the term ‘multivalent’ in the context of an anion ‘A″-’ refers to its valency n, n being at least 2.

One of the examples of a group of polymers that is of interest for recycling by depolymerization is represented by the group of terephthalate polymers that include polyesters comprising terephthalate in the backbone. The most common example of a terephthalate polymer is polyethylene terephthalate, also known as PET. Alternative examples include polybutylene terephthalate, polypropylene terephthalate, polyethylene isophthalate, poly pentaerythrityl terephthalate and copolymers thereof, such as copolymers of ethylene terephthalate and polyglycols, for instance polyoxymethylene glycol and poly(tetramethylene glycol) copolymers. PET is one of the most common polymers and it is highly desired to be able to recycle PET by depolymerization thereof into its monomers and oligomers.

One preferred way of depolymerizing PET is glycolysis, which is preferably catalysed. A suitable depolymerization by glycolysis is for instance known from WO2016/105200 in the name of the present applicant. Typically, an alcohol such as ethylene glycol is added to the reaction mixture as a reactive solvent. Degradation of the PET at suitable reaction conditions results in a reaction mixture that comprises monomers comprising bis(2-hydroxyethyl) terephthalate (BHET). According to this method, PET is depolymerized by glycolysis in the presence of a reusable catalyst. At the end of the depolymerization process a first phase comprising the BHET monomer is separated from a second phase comprising catalyst, oligomers and optionally additives. The first phase may comprise impurities in dissolved form and as dispersed particles. The BHET monomer may be obtained in a pure form by means of crystallization for instance. A high purity may be required for reuse of the depolymerized monomers and oligomers, for instance when repolymerizing them to obtain a polymer again.

The invented method may be uses for depolymerizing PET but may also be used for depolymerizing other condensation polymers such as polyesters in general, polyamides, polyurethanes and polycarbonates. According to the invention, the polymer to be depolymerized and a solvent are provided as a reaction mixture in a reactor, wherein the solvent is a reactant capable of reacting with the polymer to degrade the polymer into monomers and oligomers. Typical solvents to be used are alkanols and alkanediols, such as ethylene glycol, methanol, diethylene glycol, propylene glycol, dipropylene glycol. Ethylene glycol has been found suitable in view of its desirable physical properties, such as a boiling point around 200° C. When depolymerizing PET for instance, the use of ethylene glycol leads to bis(2-hydroxyethyl) terephthalate (BHET) as primary depolymerization product. Dimers, trimers and further oligomers may also be obtained.

The depolymerization reaction itself may be carried out in a variety of reactor types, such as batch and continuous reactors. The latter make use of flow chemistry, wherein a chemical depolymerization reaction is proceeding in a continuously flowing medium contrary to what happens in batch production.

According to step b) of the claimed method, a reusable catalyst is provided that is capable of degrading the polymer into its monomers and oligomers. Such reusable catalyst is provided to the reaction mixture. The invention may be carried out using any reusable catalyst suitable for the purpose. In a depolymerization method according to an embodiment, the catalyst may form a dispersion in the reaction mixture during step c).

In an embodiment of the invention, (nano) particles may be used as reusable catalyst. Reactions in the liquid phase may require small particles, because the diffusion rate in liquids may be smaller by several orders of magnitude, compared to gaseous diffusion rates. Nanoparticles have a small diameter and a surface area of in the range of from 0.5 up to 200 m²/g. Nanoparticles are highly active, which is believed to result in faster depolymerization and therewith an economically feasible process. Suitable reusable catalysts may be based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as magnetite, hematite, and maghemite may be used. While the use of magnetic materials principally allows separation by means of magnetic attraction, many nanoparticles are so small that they may not be attracted sufficiently on their own. However, by applying a magnetic field, the nanoparticles may form magnetic clusters, which are separated more easily by magnetic forces. Generating larger-sized clusters of nanoparticles may also be achieved by adding other clustering compounds. This may be done for both magnetic and non-magnetic nanoparticle catalysts. It should be noted that the nanoparticles may also be separated from the reaction mixture by other methods, such as by filtration and/or (ultra) centrifugation for instance.

One class of suitable reusable catalysts includes the transition metals, in their metallic or ionic form. The ionic form includes free ions in solutions and in ionic bonds or covalent bonds. Ionic bonds form when one atom gives up one or more electrons to another atom. Covalent bonds form with interatomic linkage that results from the sharing of an electron pair between two atoms. The transition metal may be chosen from the first series of transition metals, also known as the 3d orbital transition metals. More particularly, the transition metal is chosen from iron, nickel and cobalt. Since cobalt however may be unhealthy and iron and nickel particles may be formed in pure form, iron and nickel particles are most preferred. Furthermore, use can be made of alloys of the individual transition metals.

The (nano) particles are preferably of a magnetic nature, either comprising a magnetic material, or having the ability to be magnetized sufficiently under relatively modest magnetic fields, such as being applied in the present method. Suitably, the magnetic (nano) particles contain an iron, nickel and/or cobalt, in their oxidic or metallic form, or combinations thereof. Iron oxide, for instance but not exclusively in the form of Fe₃O₄ is preferred. Another suitable example is Fe₂O₃. From the alloys a suitable example is CoFe₂O₄. Other preferred examples are NiFe₂O₄, Ni₂Fe₂O₅ or NiO. If a nanoparticle is made of metal, it may be provided with an oxide surface, which may further enhance catalysis. The oxide surface may be formed by itself, in contact with air, in contact with water, or the oxide surface may be applied deliberately.

It has been found that the (nano) particles preferably are sufficiently small for the catalyst complex to function as a catalyst, therewith degrading the polymer into smaller units, wherein the yield of these smaller units, and specifically the monomers thereof, is high enough for commercial reasons. The (nano) particles in other preferred embodiments are sufficiently large in order to be able to reuse them by recovering the present catalyst. It is economically unfavorable that the catalyst would be removed with either waste or degradation product obtained. Preferred nanoparticles have an average diameter in the range of from 2 up to 500 nm, more preferably in the range of from 3 up to 200 nm, even more preferably from 4 up to 100 nm. It is noted that the term “size” relates to an average diameter of the particles, wherein an actual diameter of a particle may vary somewhat due to characteristics thereof. In addition, aggregates may be formed, for instance in the solution. These aggregates typically have sizes in a range of 50-200 nm, such as 80-150 nm, for instance around 100 nm. It is preferred to use nanoparticles comprising iron oxide.

Particle sizes and a distribution thereof can be measured by light scattering, for instance using a Malvern Dynamic light Scattering apparatus, such as a NS500 series. In a more laborious way, typically applied for smaller particle sizes and equally well applicable to large sizes representative electron microscopy pictures are taken and the sizes of individual particles are measured on the picture. For an average particle size, a number weight average may be taken. In an approximation the average may be taken as the size with the highest number of particles or as a median size.

Most preferred is the use of iron or iron-containing particles. Besides that iron or iron-containing particles are magnetic, they have been found to catalyse depolymerization of PET for instance to conversion rates into monomer of 70-90% within an acceptable reaction time of at most 6 hours, depending on catalyst loading and other processing factors such as the PET/solvent ratio. The needed concentration of catalyst is 1 wt % relative to the amount of PET or less. Good results also have been achieved with a catalyst loading below 0.2 wt % and even below 0.1 wt % relative to the amount of PET. Such a low loading of the catalyst is highly beneficial, and the invented method allows to recover an increased amount of the nanoparticle catalyst.

Non-porous metal particles, in particular transition metal particles, may be suitably prepared by thermal decomposition of carbonyl complexes such as iron pentacarbonyl and nickel tetracarbonyl. Alternatively, iron oxides and nickel oxides may be prepared via exposure of the metals to oxygen at higher temperatures, such as 400° C. and above. A non-porous particle may be more suitable than a porous particle, since its exposure to the alcohol may be less, and therefore, the corrosion of the particle may be less as well, and the particle may be reused more often for catalysis. Furthermore, due to the limited surface area, any oxidation at the surface may result in a lower quantity of metal-ions and therewith a lower level of ions that are present in the product stream as a contaminant to be removed therefrom.

Non-porous according to the invention are particles with a surface area suitably less than 10 m²/g, more preferably at most 5 m²/g, even more preferably at most 1 m²/g. The porosity is suitably less than 10⁻³/g or even less for instance at most 10⁻³ cm³/g.

Another class of suitable catalysts includes nanoparticles based on earth alkali element selected from beryllium (Be), magnesium (Mg), calcium (Ca), strontium (Sr) and barium (Ba), and their oxides. A preferred earth alkali metal oxide is magnesium oxide (MgO). Other suitable metals include but are not limited to titanium (Ti), zirconium (Zr), manganese (Mn), zinc (Zn), aluminum (Al), germanium (Ge) and antimony (Sb), as well as their oxides, and further alloys thereof. Also suitable are precious metals, such as palladium (Pd) and platinum (Pt). MgO and ZnO have been found to catalyse the depolymerization of PET for instance to conversion rates into monomer of 70-90% within an acceptable reaction time, depending on catalyst loading and other processing factors such as the PET/solvent ratio. Suitable catalysts based on hydrotalcites are also considered.

Preferably, the nanoparticles are selected to be substantially insoluble in the (alcoholic) reactive solvents, also at higher temperatures of more than 100° C. Oxides that readily tend to dissolve at higher temperatures in an alcohol such as ethylene glycol, such as for instance amorphous SiO₂, are less suitable.

Suitable catalysts to be used in the method according to the invention may be coated. For example, Fe₃O₄-particles may be coated with a material to protect the particles from oxidation to Fe₂O₃ comprising different magnetic properties. The surface of the catalyst particles may for instance be coated with a material like polyethyleneimine (PEI), polyethylene glycol (PEG), silicon oil, fatty acids like oleic acid or stearic acid, silane, a mineral oil, an amino acid, or polyacrylic acid or, polyvinylpyrrolidone (PVP). Carbon is also possible as coating material.

The coating may be removed before or during the catalytic reaction. Ways to remove the coating from the catalytic particle may comprise using a solvent wash step separately before using it in the reactor, or by burning it in air.

A particularly preferred catalyst relates to a catalyst complex (hereinafter referred to as ‘ABC’ or ‘MF’), which comprises three distinguishable elements: a (nano) particle (A), a bridging moiety/linking group (B) attached to the particle chemically, such as by a covalent bond, or physically, such as by adsorption, and a catalyst entity (C) that is associated with the particles (A), such as by being chemically bonded, for instance covalently bonded, to the linking group. The linking group preferably does not fully cover the nanoparticle surface, such as in a core-shell particle.

The particles of this catalyst complex are preferably based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as magnetite, hematite, and maghemite can be used. In view of costs, even when fully or largely recovering the present catalyst complex, relatively cheap particles are preferred, such as particles comprising Fe. A further advantage of particles of iron or iron oxides is that they have highest saturation magnetisation, making it easier to separate the particles via a magnetic separator. And even more importantly, the iron oxide nanoparticles have a positive impact on the degradation reaction. The iron oxide may further contain additional elements such as cobalt and/or manganese, for instance CoFe₂O₄.

Preferably, the (nano) particles are selected to be substantially insoluble in the (alcoholic) reactive solvents, also at higher temperatures of more than 100° C. Oxides that readily tend to dissolve at higher temperatures in an alcohol such as ethylene glycol, such as for instance amorphous SiO₂, are less suited.

The present catalyst entity comprises at least two moieties. A first moiety relates to a moiety having a positive charge (cation). A second moiety relates to a moiety, typically a salt complex moiety, having a negative charge (anion). The negative and positive charges typically balance one another. It has been found that the positively and negatively charged moieties have a synergistic and enhancing effect on the degradation process of waste terephthalate polymer in terms of conversion and selectivity.

The positively charged moiety (cation) may be aromatic or aliphatic, and/or heterocyclic. The cationic moiety may be aliphatic and is preferably selected from guanidinium (carbamimidoylazanium), ammonium, phosphonium and sulphonium. A non-aromatic or aromatic heterocyclic moiety preferably comprises a heterocycle, having at least one, preferably at least two hetero-atoms. The heterocycle may have 5 or 6 atoms, preferably 5 atoms. The positively charged moiety may be an aromatic moiety, which preferably stabilizes a positive charge. Typically the cationic moiety carries a delocalized positive charge. The hetero-atom may be nitrogen N, phosphor P or sulphur S for instance. Suitable aromatic heterocycles are pyrimidines, imidazoles, piperidines, pyrrolidine, pyridine, pyrazol, oxazol, triazol, thiazol, methimazol, benzotriazol, isoquinol and viologen-type compounds (having f.i. two coupled pyridine-ring structures). Particularly preferred is an imidazole structure, which results in an imidazolium ion. Particularly suitable cationic moieties having N as hetero-atom comprise imidazolium, (5-membered ring with two N), piperidinium (6-membered ring with one N), pyrrolidinium (5-membered ring having one N), and pyridinium (6-membered ring with one N). Preferred imidazolium cationic moieties comprise butylmethylimidazolium (bmim⁺), and dialkylimidazoliums. Other suitable cationic moieties include but are not limited to triazolium (5-membered ring with 3 N), thiazolidium (5-membered ring with N and S), and (iso) quiloninium (two 6-membered rings (naphthalene) with N).

In a preferred method, the cationic moiety of the catalyst entity is selected from at least one of an imidazolium group, a piperidinium group, a pyridinium group, a pyrrolidinium group, a sulfonium group, an ammonium group, and a phosphonium group.

Said cationic moiety may have one ore more substituents, which one ore more substituents is preferably selected an alkyl moiety. In particular examples, said alkyl moiety has a length of C₁-C₆, such as C₂-C₄. In specific examples, said imidazolium group has two substituents R₁, R₂ attached to one of the two nitrogen atoms, respectively, said piperidinium group has two substituents R₁, R₂ attached to its nitrogen atom, said pyridinium group has two substituents R₁, R₂ wherein one of the two substituents R₁, R₂ is attached to its nitrogen atom, said pyrrolidinium group has two substituents R₁, R₂ attached to its nitrogen atom, said sulphonium group has three substituents R₁, R₂, R₃ attached to its sulphur atom, said ammonium group has four substituents R₁, R₂, R₃, R₄ attached to its nitrogen atom, and said phosphonium group has four substituents R₁, R₂, R₃, R₄ attached to its phosphor atom, respectively.

The negatively charged moiety (anion) may relate to an anionic complex, but alternatively to a simple ion, such as a halide. It may relate to a salt complex moiety, preferably a metal salt complex moiety, having a two- or three-plus charged metal ion, such as Fe³⁺, Al³⁺, Ca²⁺, Zn²⁺ and Cu²⁺, and negatively charged counter-ions, such as halogenides, e.g. Cl, F, and Br. In an example the salt is a Fe³⁺ comprising salt complex moiety, such as an halogenide, e.g. FeCl₄⁻. Alternatively, use can be made of counter-ions without a metal salt complex, such as halides as known per se.

The linking group may comprise a bridging moiety for attaching the catalyst entity to the catalyst particle. The present catalyst entity and particle are combined by the bridging moiety by attaching the catalyst entity to the catalyst particle. The attachment typically involves a physical or chemical bonding between a combination of the bridging moiety and the catalyst entity on the one hand and the catalyst particle on the other hand. Particularly, a plurality of bridging moieties is attached or bonded to a surface area of the present catalyst particle. Suitable bridging moieties comprise a weak organic acid, silyl comprising groups, and silanol. More particularly, therefore, the bridging moiety comprises a functional group for bonding to the oxide of the particle and a second linking group for bonding to the catalyst entity. The functional group is for instance a carboxylic acid, an alcohol, a silicic acid group, or combinations thereof. Other acids such as organic sulphonic acids are not excluded. The linking group comprises for instance an end alkyl chain attached to the cationic moiety, with the alkyl chain typically between C₁ and C₆, for instance propyl and ethyl. The linking group may be attached to the cationic moieties such as the preferred imidazolium moiety. In the attached state, a BC complex then for instance comprises imidazolium having two alkyl groups, such as butylmethylimidazolium (bmim+) or ethylmethylimidazolium as an example.

The bridging moiety is suitably provided as a reactant, in which the linking group is functionalized for chemical reaction with the catalyst entity. For instance, a suitable functionalization of the linking group is the provision as a substituted alkyl halide. Suitable reactants for instance include 3-chloropropyltrialkoxysilane and 3-bromopropyltrialkoxysilane. The alkoxy-group is preferably ethoxy, although methoxy or propoxy groups are not excluded. It is preferred to use trialkoxysilanes, although dialkyldialkoxysilanes and trialkyl-monoalkoxysilanes are not excluded.

In the latter cases, the alkyl groups are preferably lower alkyl, such as C₁-C₄ alkyl. At least one of the alkyl groups is then functionalized, for instance with a halide, as specified above.

The said reactant is then reacted with the catalyst entity. Preferably, this reaction generates the positive charge on the cationic moiety, more particularly on a hetero-atom but mostly delocalized, in the, preferably heterocyclic, cationic moiety. The reaction is for instance a reaction of a (substituted) alkyl halide with a hetero-atom, such as nitrogen, containing cationic moiety, resulting in a bond between the hetero-atom and the alkyl-group. The hetero-atom is therewith charged positively, and the halide negatively. The negatively charged halide may thereafter be strengthened by addition of a Lewis acid to form a metal salt complex. One example is the conversion of chloride to FeCl₄⁻.

According to an embodiment of the present invention, the bridging moiety and the catalyst entity bonded thereto are provided in an amount of (mole bridging moiety/gr magnetic particle) 5*10⁻⁶-0.1, preferably 1*10⁻⁵-0.01, more preferably 2*10⁻⁵-10⁻³, such as 4*10⁻⁵-10⁻⁴. It is preferred to have a relatively large amount available in terms of an effective optional recovery of the catalyst complex, whereas, in terms of amount of catalyst and costs thereof, a somewhat smaller amount may be more preferred.

It has been found that limited coverage of the surface of the nanoparticles, or aggregate of such particles, with the catalyst group is sufficient to obtain an effective reusable catalyst. It is assumed that if a predetermined amount (moles) of bridging moiety is attached to a predetermined amount (gr) substantially all the bridging moieties attach to the nanoparticle and substantially stay attached during the present method.

The reusable catalyst, to the extent that it is not dissolved in the solvent but heterogeneous, can be recovered to a large extent. In step d) of the invented method, the catalyst is recovered from the reaction mixture. Separation may occur in many ways, such as by magnetic separation, by filtration or by centrifuging in a centrifuge for instance. The presence of any aggregates is deemed advantageous, as it may render the phase separation more effective.

The invented method further comprises adding a salt to the reaction mixture in at least one of the reaction steps a), b), c) or d). According to the invention, the salt has at least one multivalent monoatomic or polyatomic anion. The effect of adding the salt is that the degradation reaction of the polymer to its monomers and oligomers is improved by either a reduction of the reaction time (an increase of the conversion rate) and/or an increase in the amount of recovered reusable catalyst and/or a reduction in the formation of undesirable side-products at substantially full conversion, such as BHEET in the case of depolymerizing PET.

It may be important to avoid producing too much BHEET in the reactor during depolymerization. BHEET is defined by Formula I:

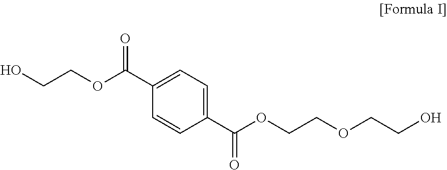 [SMILES: O=C(OCCO)c1ccc(C(=O)OCCOCCO)cc1]

The salt may be added to step a), together with the polymer or with the solvent, or separately. The salt may be added as a solid, or dissolved in water or in a solvent, depending on the nature of the salt. The salt may also be added in step b) of the method, together with the reusable catalyst or separately. It can furthermore be added in step c) of the method, before or during the degradation of the polymer in the reaction mixture. Finally, it can even be added in step d) of the method before or during recovering the catalyst from the reaction mixture. It is also possible to add the salt in more than one of the steps a) to d). The salt added to the reaction mixture surprisingly influences the separation of the reusable catalyst from the reaction mixture in that separation is improved and the catalyst is recovered more easily and in larger amounts.

In an embodiment of the method, the amount of salt added to the reaction mixture relative to the amount of catalyst ranges from 0.1:1 to 40:1, preferably from 0.5:1 to 30:1, more preferably from 0.8:1 to 5:1, and most preferably from 0.8:1 to 2:1.

According to an embodiment of the method as claimed, the salt comprises at least one of a neutral salt, a basic salt, an acidic salt, and a complex salt. These salts have their usual meaning. A neutral salt ensues when a strong base reacts with a strong acid, while a basic salt is formed when a strong base reacts with a weak acid, while an acidic salt is formed by reacting a strong acid with a weak base. Complex salts have a central metal atom with coordination bonds of ligands around it.

Although many salts as claimed are able to produce the advantages of the claimed invention, a method according to an embodiment in which the salt is selected from metal sulphates, metal carbonates, metal phosphates and metal citrates is particularly preferred.

Preferred metals may be selected from but are not limited to potassium, sodium, iron, zinc and magnesium.

Particularly preferred salts comprise potassium sulphates, carbonates, potassium phosphates and potassium citrates; sodium sulphates, sodium carbonates, sodium phosphates and sodium citrates; iron sulphates, iron carbonates, iron phosphates and iron citrates; zinc sulphates, zinc carbonates, zinc phosphates and zinc citrates; and further magnesium sulphates, magnesium carbonates, magnesium phosphates and magnesium citrates.

It has turned out that certain salts as claimed perform less well. According to an embodiment therefore, a method is provided wherein metal phosphates are excluded. Metal phosphates tend to decrease the catalytic activity of the reusable catalyst, in particular when using in relatively large amounts such as an amount relative to the amount of catalyst of more than 1:1.

According to another embodiment, a method is provided wherein the use of sodium carbonate in the reaction mixture in an amount relative to the amount of catalyst of from 25:1 to 35:1 is excluded.

In preferred embodiment of the invented method, water is added to the reaction mixture prior to or during the recovery of the catalyst in step d). Water can be added separately or, in a preferred embodiment, together with the salt. The step of adding water with or without the salt to said reaction mixture results in a first aqueous phase comprising monomer and dimer, and a second phase comprising oligomer, catalyst complex and aggregates, and separating the first phase from the second phase. This has turned out an effective manner to remove various contaminants. In a preferred embodiment hereof, the second phase is processed to reduce its water content and thereafter recycled into the reactor vessel and reused in step a). The reduction of water content may be carried out in several ways, for instance by means of evaporation, such as by distillation and/or by membrane distillation.

The recovering step d) according to the invented method preferably comprises separating the catalyst from the reaction mixture. The separation step is more preferably performed using a centrifuge. Alternatively, the separation step is preferably performed using magnetic separation and/or application of an electric field. In a preferred embodiment wherein water is added to the reaction mixture, the separation is preferably performed at a temperature of between 60° C. and 100° C., more preferably of between 75° C. and 95° C. If no water is present, separation can be performed at higher temperatures.

Advantageously, water or aqueous solution that is added to the reaction mixture prior to or during the recovery of the catalyst may act as coolant. It may be provided at ambient temperature or any higher temperature and is preferably liquid. Still, it is not excluded that separate cooling means are provided. Due to the addition of water or an aqueous solution, two phases will appear, of which the first is an aqueous phase comprising solvent, monomer and at least some dimer and trimer. The second phase is a slurry comprising a variety of solids, including catalyst, oligomers, trimers and the solvent.

The water added to the reaction mixture in step d) is preferably in an amount such that the weight ratio of water to solvent ranges from 0.2 to 5.0, more preferably from 0.5 to 1.5, even more preferably from 0.7 and 1.3, and most preferably from 0.9 and 1.1. The more water is added, the more precipitation of catalyst and oligomers generally takes place. However, this also generally means that more water needs to be distilled to isolate or reuse the catalyst and oligomers.

In a preferred embodiment in which both salt and water are added, the weight ratio of salt to water ranges from 0.0001 to 0.02, more preferably from 0.0006 to 0.007, and most preferably from 0.001 to 0.002.

In accordance with other embodiments of the invention, the recovering step d) is preferably performed directly after the water and/or salt addition to the reaction mixture.

In an embodiment of the invention, the addition of water and, optionally the salt, to the reaction mixture prior to or during the recovering of the reusable catalyst in step d) is performed at a temperature below 160° C., preferably below 140° C., more preferably below 120° C., and most preferably below 110° C.

Advantageously, after the degrading step the reaction mixture is cooled to below 170° C. before the water and/or salt adding step. The water preferably has a temperature of at least 85° C.

The depolymerization step c) may involve glycolysis of PET, in which an ethylene glycol solvent is also a reactant to obtain BHET, rather than for instance terephthalic acid that would be generated in hydrolysis. A polymer concentration in the reaction mixture or dispersion is typically from 1-30 wt. % of the total weight of the reaction mixture, although concentrations outside this range may also be possible.

The amount of solvent, preferably a polyol such as ethylene glycol (EG), in the reaction mixture may be chosen within wide ranges. In a useful embodiment, the weight ratio of solvent to the polymer is in the range of from 10:10 to 100:10, more preferably from 20:10 to 90:10, even more preferably from 30:10 to 80:10, and most preferably from 40:10 to 60:10.

The reaction mixture is heated in step d) to a suitable temperature which is preferably maintained during depolymerization. The temperature may be selected in the range of from 160° C. to 250° C. It has turned out that a higher temperature in conjunction with the reusable catalyst yields a relatively low amount of side-products in the reaction mixture and the ensuing product stream. In preferred embodiments therefore, the degrading step d) may comprise forming the monomer at a temperature in the range of from 185° C. to 225° C. Suitable pressures in the reactor are from 1-5 bar, wherein a pressure higher than 1.0 bar is preferred, and more preferably lower than 3.0 bar.

An average residence time of the monomer during the degrading step d) may range from 30 sec-3 hours, and longer. In order to stop the depolymerization reaction and/or deactivate the reusable catalyst, the temperature may be reduced to a temperature below 160° C. or lower, but preferably not lower than 85° C.

The monomer in the product stream may be recovered according to a number of methods. In a useful embodiment, recovering the monomer comprises a crystallization step wherein the depolymerized product stream is cooled, by passing through a heat exchanger for instance or, preferably, by adding water to the depolymerized product stream. In this way, a decrease of the temperature from the temperature of the degrading step d) to a crystallization temperature is achieved. Thereby monomer crystals are produced in the depolymerized product stream, thereby obtaining a mixture of monomer crystals and a mother liquor as monomer-depleted stream comprising at least the solvent and eventual side-products. The crystallization temperature is preferably selected below 85° C., and may comprise a temperature between ambient and 85° C.

In an advantageous implementation, the crystallization temperature of the monomer crystallization is in the range of 10° C.-70° C., such as around 55° C., although lower temperatures may also be chosen, preferably in the range of 15° C.-40° C., more preferably about 18-25° C. The crystallization temperature is herein defined as the temperature defined at the start of the crystallization step, thus typically at which the nucleation occurs. It is not excluded that the temperature changes or is actively modified during the crystallization.

The amount of catalyst relative to the amount of polymer is rather low. Preferably, it ranges from 0.001:10 to 1:10, more preferably from 0.005:10 to 0.3:10, and most preferably from 0.008 to 0.015:10.

Another aspect of the invention relates to a salt having at least one multivalent monoatomic or polyatomic anion for use as a recovery-enhancing agent and/or a co-catalyst for the reusable catalyst in the catalytic degradation of a polymer in the reaction mixture at the reaction conditions. The salt may also be active in the depolymerization reaction, for instance in increasing conversion rate, and since it preferably stays in the system, it may be of influence in both the depolymerization reaction as well as the recovery of the reusable catalyst.

The salt is preferably selected from metal sulphates, metal carbonates, metal phosphates and metal citrates, wherein the metal is selected from potassium, sodium, iron, zinc and magnesium.

In another embodiment, the salt is for use as a recovery-enhancing agent and/or a co-catalyst for a reusable catalyst that comprises a catalyst complex comprising a catalyst entity, a metal containing nanoparticle, and a bridging moiety connecting the catalyst entity to the magnetic nanoparticle, wherein the catalyst entity comprises a cationic moiety having a positive charge, and an anionic moiety, having a negative charge, and preferably providing a negative counterion.

### BRIEF DESCRIPTION OF THE FIGURES

The above and other advantages of the features and objects of the invention will become more apparent, and the invention will be better understood from the following detailed description when read in conjunction with the accompanying drawings, in which:

FIG. 1 illustrates the concentration of BHET with depolymerization reaction time and the separation efficiency of the reusable catalyst ABC for the known method and according to embodiments of the invented method;

FIG. 2 illustrates the concentration of BHET with depolymerization reaction time and the separation efficiency of the reusable catalyst ABC for the known method and according to embodiments of the invented method;

FIG. 3 illustrates the concentration of BHET with depolymerization reaction time and the separation efficiency of the reusable catalyst ABC for the known method;

FIG. 4 illustrates the concentration of BHET with depolymerization reaction time of the reusable ABC catalyst for the known method;

FIG. 5 illustrates the concentration of BHET with depolymerization reaction time and the separation efficiency of the reusable catalyst ABC for the known method and according to embodiments of the invented method;

FIG. 6 illustrates the concentration of BHET with depolymerization reaction time and the separation efficiency of the reusable catalyst ABC for the known method;

FIG. 7 illustrates the concentration of BHET with depolymerization reaction time and the separation efficiency of the reusable catalyst ABC for the known method; and finally

FIG. 8 illustrates the concentration of BHET with depolymerization reaction time of the reusable ABC catalyst for the known method.

### DESCRIPTION OF EMBODIMENTS

The following, non-limiting examples are provided to illustrate the invention. In the experiments, the catalyst ABC refers to the reusable catalyst that is recovered and separated. It is based on iron particles with a silanol bridging group and an imidazolium moiety. However, other heterogeneous catalyst systems also showed satisfactory results.

### EXPERIMENTS

### Comparative Experiment A: Catalyst ABC

Depolymerization experiments were carried out using a 500 ml round bottom flask. 0.068 g of an iron-based ABC catalyst complex were used with 33.4 g of polyethylene terephthalate (PET) flakes (pieces of 0.1×0.02 cm²) and 250 g of ethylene glycol. The round bottom flask was placed in the heating setup. The heating was started, and after 20 minutes, the reaction mixture had reached the reaction temperature of 197° C. The reaction was followed in time by taking in-process-control samples to measure the concentration of monomer (bis(2-hydroxyethyl) terephthalate, or BHET) produced as a function of time. The concentration of BHET was determined with HPLC.

After 240 min at 197° C., the reaction was stopped by cooling down below 160° C. The reaction mixture was transferred to a beaker through a sieve filter to remove the remaining solids. Water was added to obtain the water:EG ratio of 0.8:1. The mixture was mixed. A sample before centrifuging was taken. The mixture was transferred to centrifuge tubes and centrifuged at 4000 rpm for 3 min. A sample after centrifuging was taken. The samples were analyzed by XRF to determine separation efficiency of ABC.

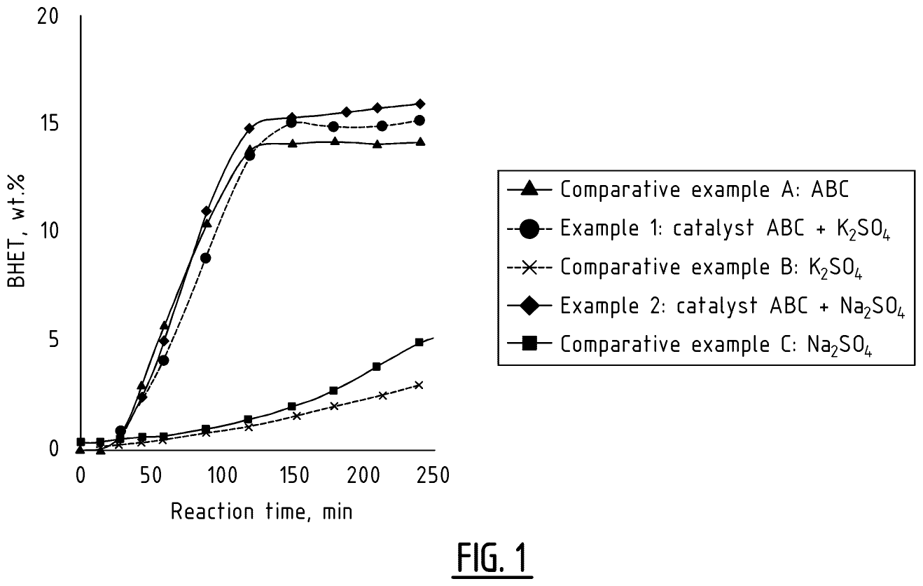

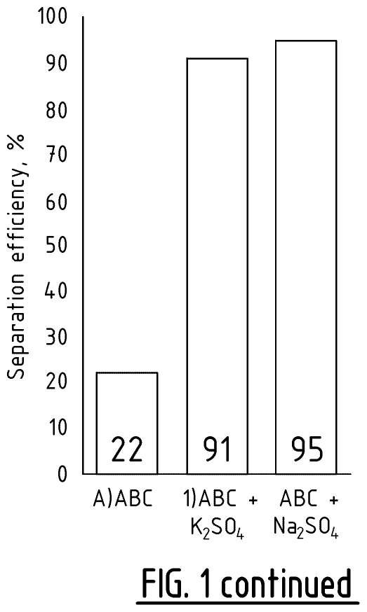

In FIG. 1 the concentration of BHET as function of the reaction time and the results of separation efficiency are shown.

### Example 1: Catalyst ABC+K₂SO₄

The same procedure of depolymerization reaction as described in Comparative example A was used with 0.034 g of an iron-based ABC catalyst complex and 0.034 of K₂SO₄. In FIG. 1 the concentration of BHET as function of the reaction time and the results of separation efficiency are shown.

### Comparative Example B: K₂SO₄

The same procedure of depolymerization reaction as described in Comparative example A was used with 0.034 of K₂SO₄. In FIG. 1 the concentration of BHET as function of the reaction time is shown.

### Example 2: Catalyst ABC+Na₂SO₄

The same procedure of depolymerization reaction as described in Comparative example A was used with 0.034 g of an iron-based ABC catalyst complex and 0.034 of Na₂SO₄. In FIG. 1 the concentration of BHET as function of the reaction time and the results of separation efficiency are shown.

### Comparative Example C: Na₂SO₄

The same procedure of depolymerization reaction as described in Comparative example A was used with 0.034 of Na₂SO₄. In FIG. 1 the concentration of BHET as function of the reaction time is shown.

### Example 3: Catalyst ABC+Na₂CO₃

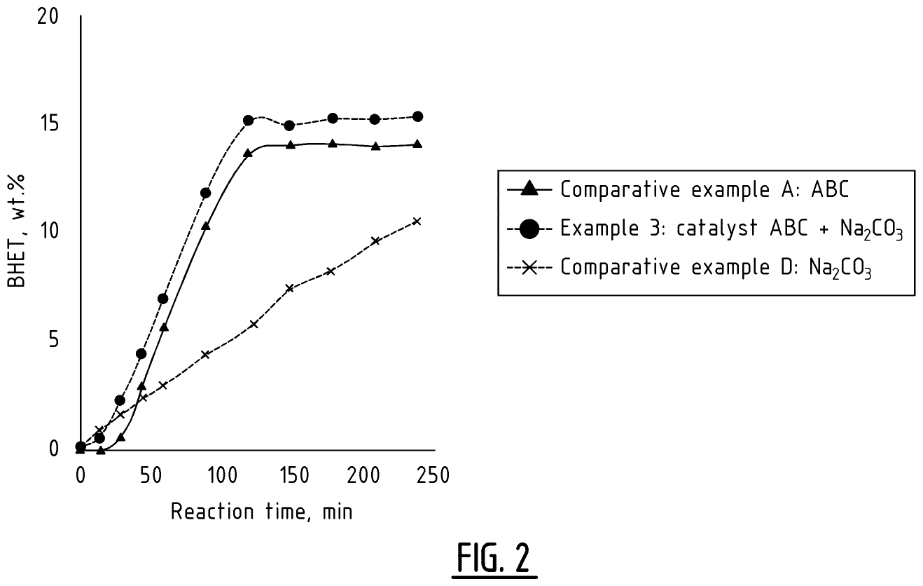

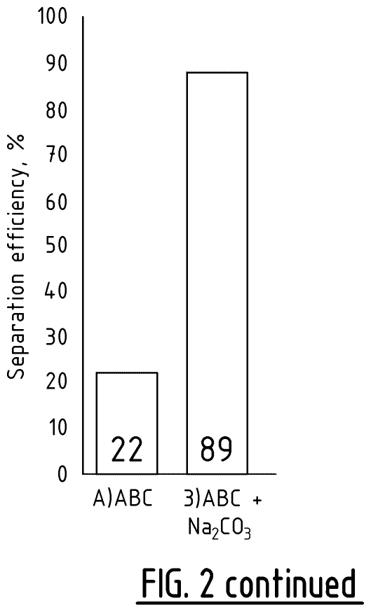

The same procedure of depolymerization reaction as described in Comparative example A was used with 0.034 g of an iron-based ABC catalyst complex and 0.034 of Na₂CO₃. In FIG. 2 the concentration of BHET as function of the reaction time and the results of separation efficiency are shown.

### Comparative Example D: Na₂CO₃

The same procedure of depolymerization reaction as described in Comparative example A was used with 0.034 of Na₂CO₃. In FIG. 2 the concentration of BHET as function of the reaction time is shown.

### Comparative Example E: Catalyst ABC+CaCl₂)

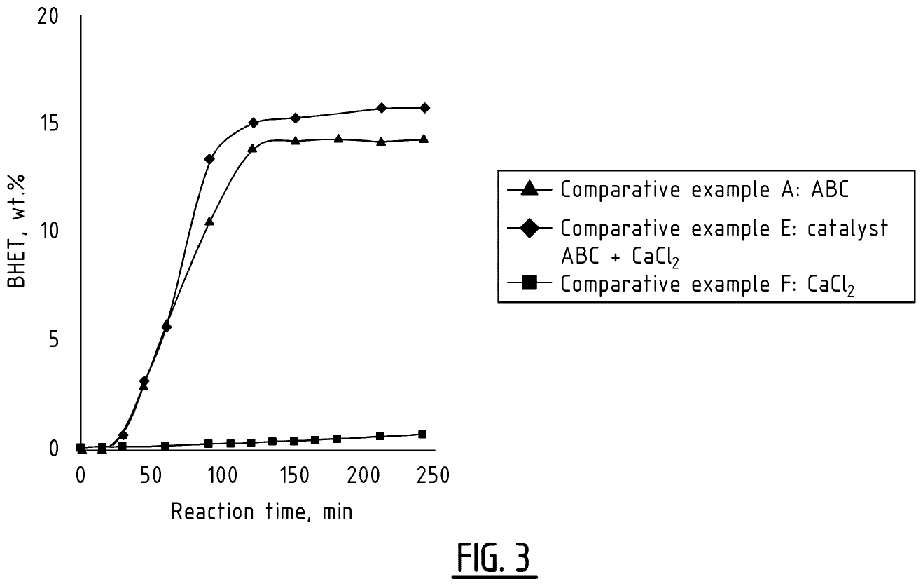

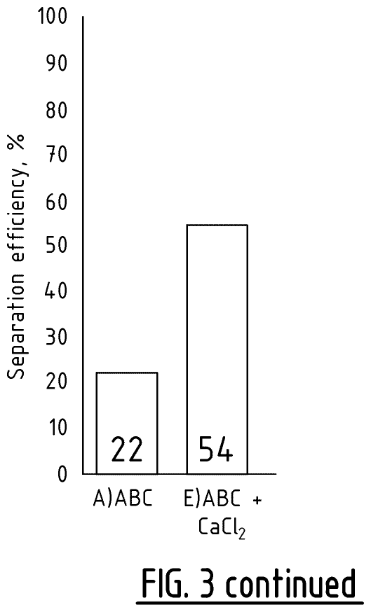

The same procedure of depolymerization reaction as described in Comparative example A was used with 0.034 g of an iron-based ABC catalyst complex and 0.034 of CaCl₂). In FIG. 3 the concentration of BHET as function of the reaction time and the results of separation efficiency are shown.

### Comparative Example F: CaCl₂)

The same procedure of depolymerization reaction as described in Comparative example A was used with 0.034 of CaCl₂). In FIG. 3 the concentration of BHET as function of the reaction time is shown.

### Comparative Example G: Catalyst ABC+KH₂PO₄

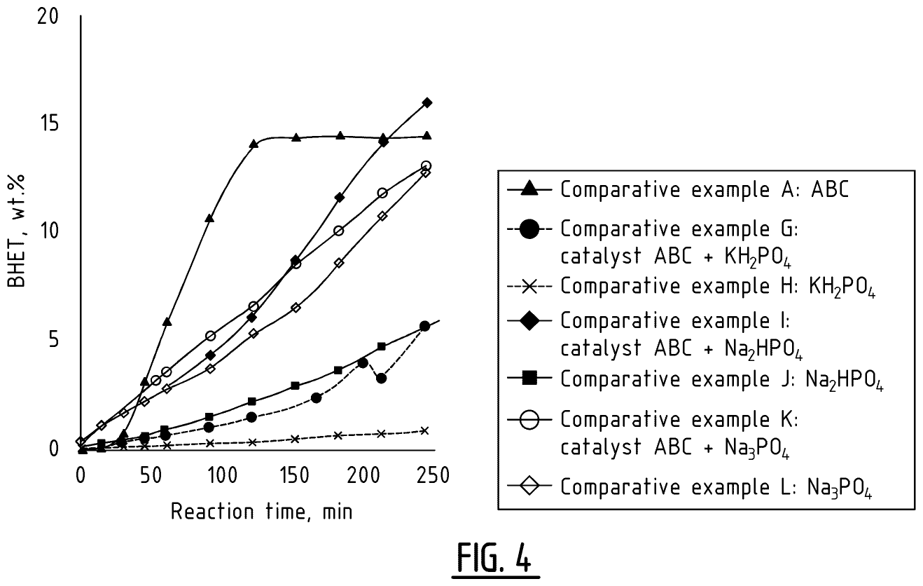

The same procedure of depolymerization reaction as described in Comparative example A was used with 0.034 g of an iron-based ABC catalyst complex and 0.051 of KH₂PO₄. In FIG. 4 the concentration of BHET as function of the reaction time are shown. No separation efficiency was measured since PET conversion was not complete.

### Comparative Example H: KH₂PO₄

The same procedure of depolymerization reaction as described in Comparative example A was used with 0.051 of KH₂PO₄. In FIG. 4 the concentration of BHET as function of the reaction time are shown.

### Comparative Example I: Catalyst ABC+Na₂HPO₄

The same procedure of depolymerization reaction as described in Comparative example A was used with 0.034 g of an iron-based ABC catalyst complex and 0.051 of Na₂HPO₄. In FIG. 4 the concentration of BHET as function of the reaction time are shown. No separation efficiency was measured since PET conversion was not complete.

### Comparative Example J: Na₂HPO₄

The same procedure of depolymerization reaction as described in Comparative example A was used with 0.051 of Na₂HPO₄. In FIG. 4 the concentration of BHET as function of the reaction time are shown.

### Comparative Example K: Catalyst ABC+Na₃PO₄

The same procedure of depolymerization reaction as described in Comparative example A was used with 0.034 g of an iron-based ABC catalyst complex and 0.051 of Na₃PO₄. In FIG. 4 the concentration of BHET as function of the reaction time are shown. No separation efficiency was measured since PET conversion was not complete.

### Comparative Example L: Na₃PO₄

The same procedure of depolymerization reaction as described in Comparative example A was used with 0.051 of Na₃PO₄. In FIG. 4 the concentration of BHET as function of the reaction time are shown.

### Comparative Example M: Catalyst ABC+NaC₆H₇O₇ (Monosodium Citrate)

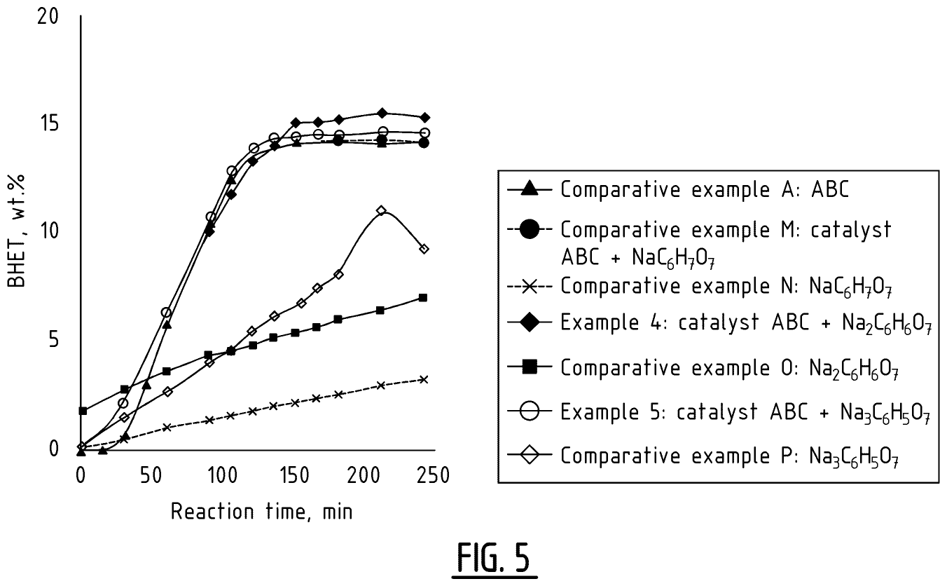

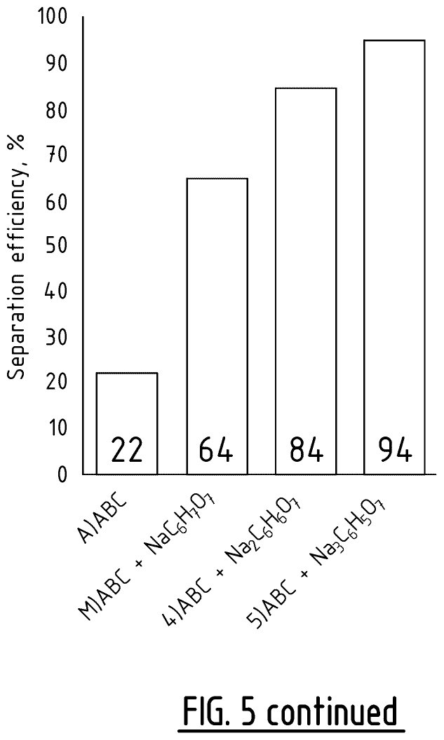

The same procedure of depolymerization reaction as described in Comparative example A was used with 0.034 g of an iron-based ABC catalyst complex and 0.034 of NaC₆H₇O₇. In FIG. 5 the concentration of BHET as function of the reaction time and the results of separation efficiency are shown.

### Comparative Example N: NaC₆H₇O₇ (Monosodium Citrate)

The same procedure of depolymerization reaction as described in Comparative example A was used with 0.034 of NaC₆H₇O₇. In FIG. 5 the concentration of BHET as function of the reaction time are shown.

### Example 4: Catalyst ABC+Na₂C₆H₆O₇ (Disodium Citrate)

The same procedure of depolymerization reaction as described in Comparative example A was used with 0.034 g of an iron-based ABC catalyst complex and 0.034 of Na₂C₆H₆O₇. In FIG. 5 the concentration of BHET as function of the reaction time and the results of separation efficiency are shown.

### Comparative Example O: Na₂C₆H₆O₇ (Disodium Citrate)

The same procedure of depolymerization reaction as described in Comparative example A was used with 0.034 of Na₂C₆H₆O₇. In FIG. 5 the concentration of BHET as function of the reaction time are shown.

### Example 5: Catalyst ABC+Na₃C₆H₅O₇ (Trisodium Citrate)

The same procedure of depolymerization reaction as described in Comparative example A was used with 0.034 g of an iron-based ABC catalyst complex and 0.034 of Na₃C₆H₅O₇. In FIG. 5 the concentration of BHET as function of the reaction time and the results of separation efficiency are shown.

### Comparative Example P: Na₃C₆H₅O₇ (Trisodium Citrate)

The same procedure of depolymerization reaction as described in Comparative example A was used with 0.034 of Na₃C₆H₅O₇. In FIG. 5 the concentration of BHET as function of the reaction time are shown.

### Comparative Example Q: Catalyst ABC+ZnO

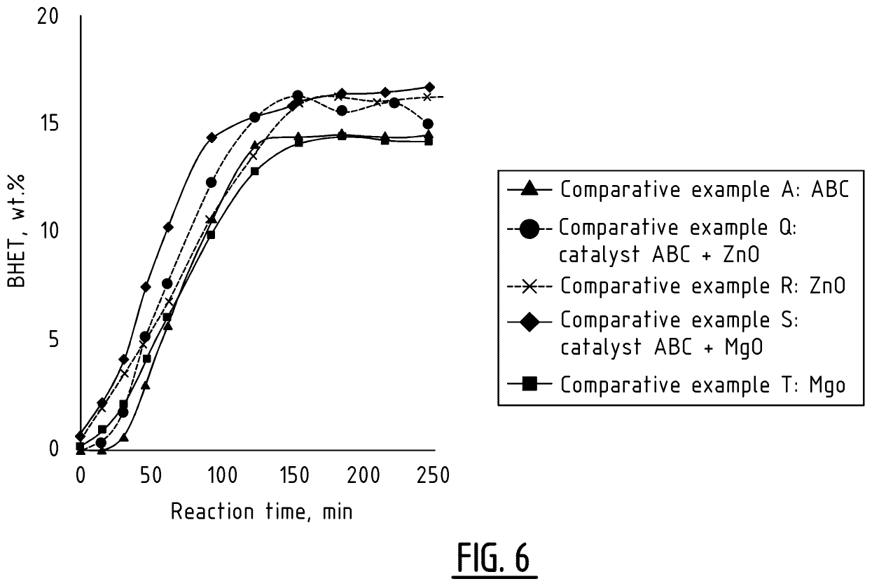

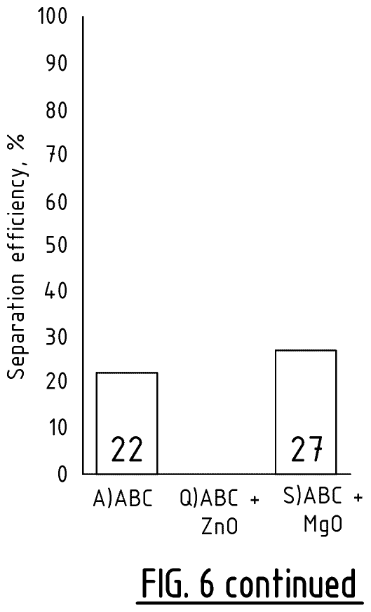

The same procedure of depolymerization reaction as described in Comparative example A was used with 0.034 g of an iron-based ABC catalyst complex and 0.034 of ZnO. ZnO is not considered a salt as claimed since it acts as a solid base catalyst in the process as claimed, i.e., ZnO does not qualify as a (dissolved) salt. In FIG. 6 the concentration of BHET as function of the reaction time and the results of separation efficiency are shown.

### Comparative Example R: ZnO

The same procedure of depolymerization reaction as described in Comparative example A was used with 0.034 of ZnO. In FIG. 6 the concentration of BHET as function of the reaction time are shown.

### Comparative Example S: Catalyst ABC+MgO

The same procedure of depolymerization reaction as described in Comparative example A was used with 0.034 g of an iron-based ABC catalyst complex and 0.034 of MgO. In FIG. 6 the concentration of BHET as function of the reaction time and the results of separation efficiency are shown. MgO is not considered a salt as claimed since it acts as a solid base catalyst in the process as claimed, i.e., MgO does not qualify as a (dissolved) salt.

### Comparative Example T: MgO

The same procedure of depolymerization reaction as described in Comparative example A was used with 0.034 of MgO. In FIG. 6 the concentration of BHET as function of the reaction time are shown.

### Comparative Example U: Catalyst ABC+Iron(II) Acetate

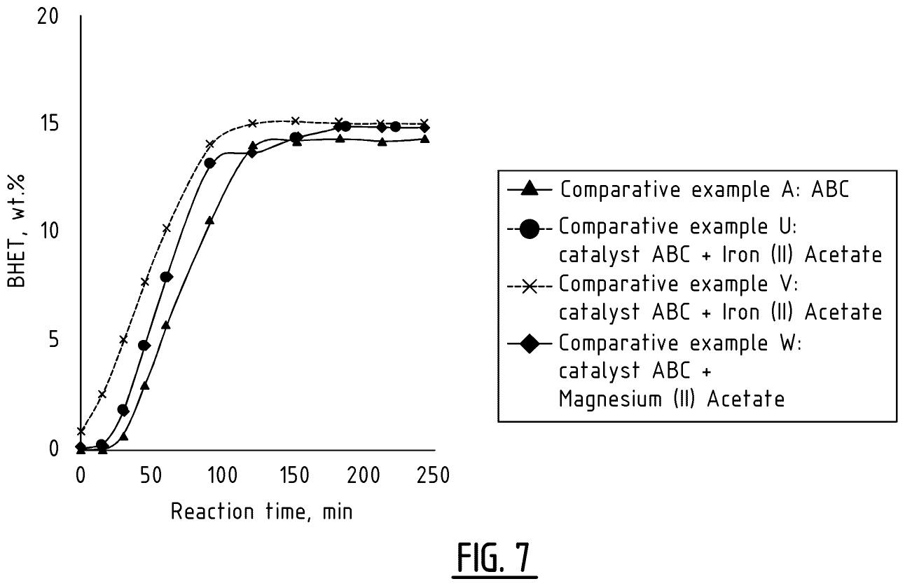

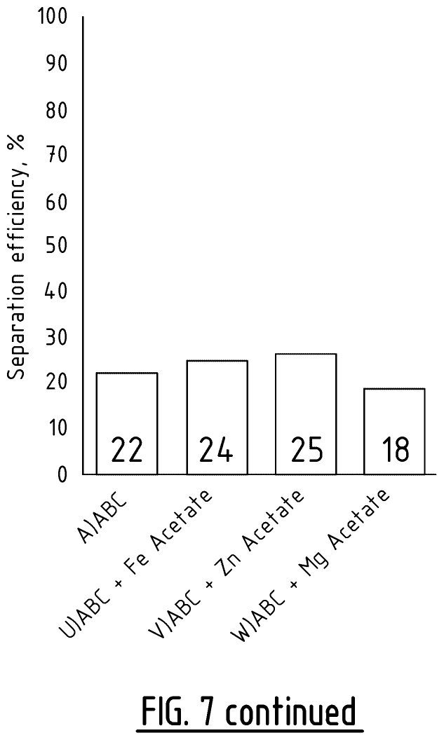

The same procedure of depolymerization reaction as described in Comparative example A was used with 0.034 g of an iron-based ABC catalyst complex and 0.034 of Iron(II) Acetate. In FIG. 7 the concentration of BHET as function of the reaction time and the results of separation efficiency are shown.

### Comparative Example V: Catalyst ABC+Zinc(II) Acetate

The same procedure of depolymerization reaction as described in Comparative example A was used with 0.034 g of an iron-based ABC catalyst complex and 0.034 of Zinc(II) Acetate. In FIG. 7 the concentration of BHET as function of the reaction time and the results of separation efficiency are shown.

### Comparative Example W: Catalyst ABC+Magnesium(II) Acetate

The same procedure of depolymerization reaction as described in Comparative example A was used with 0.034 g of an iron-based ABC catalyst complex and 0.034 of Magnesium(II) Acetate. In FIG. 7 the concentration of BHET as function of the reaction time and the results of separation efficiency are shown.

### Comparative Example X: Catalyst ABC+1-Butyl-3-Methylimidazolium Chloride

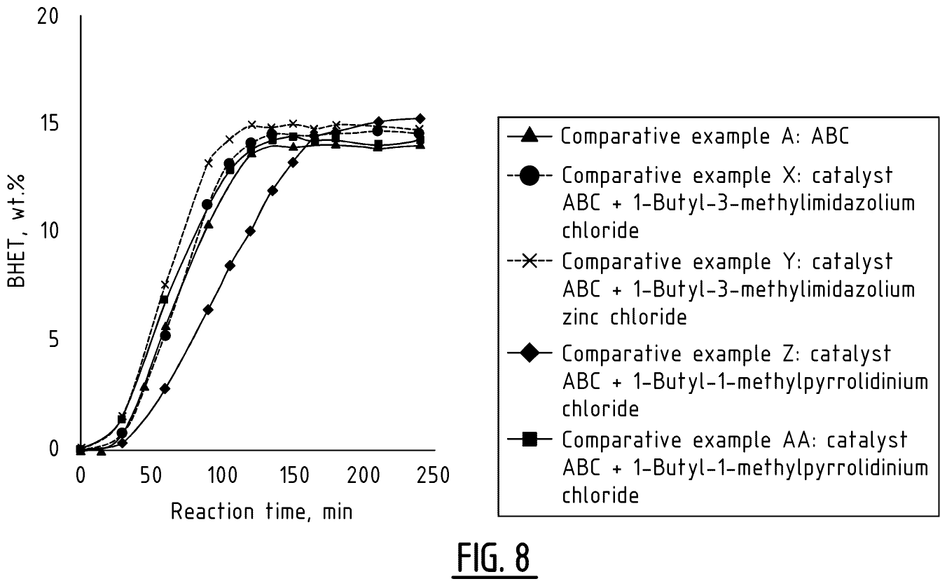

The same procedure of depolymerization reaction as described in Comparative example A was used with 0.034 g of an iron-based ABC catalyst complex and 0.034 of 1-Butyl-3-methylimidazolium chloride. In FIG. 8 the concentration of BHET as function of the reaction time is shown.

### Comparative Example Y: Catalyst ABC+1-Butyl-3-Methylimidazolium Zinc Chloride

The same procedure of depolymerization reaction as described in Comparative example A was used with 0.034 g of an iron-based ABC catalyst complex and 0.034 of 1-Butyl-3-methylimidazolium zinc chloride. In FIG. 8 the concentration of BHET as function of the reaction time and the results of separation efficiency are shown.

### Comparative Example Z: Catalyst ABC+1-Butyl-1-Methylpyrrolidinium Chloride

The same procedure of depolymerization reaction as described in Comparative example A was used with 0.034 g of an iron-based ABC catalyst complex and 0.034 of 1-Butyl-1-methylpyrrolidinium chloride. In FIG. 8 the concentration of BHET as function of the reaction time and the results of separation efficiency are shown.

### Comparative Example AA: Catalyst ABC+1-Butyl-1-Methylpyrrolidinium Zinc Chloride

The same procedure of depolymerization reaction as described in Comparative example A was used with 0.034 g of an iron-based ABC catalyst complex and 0.034 of 1-Butyl-1-methylpyrrolidinium zinc chloride. In FIG. 8 the concentration of BHET as function of the reaction time and the results of separation efficiency are shown.

1. A method for obtaining a monomer by degrading a polymer, the polymer being a condensation homopolymer or copolymer of the monomer, the method comprising the steps of
a) providing the polymer and a solvent as a reaction mixture in a reactor, wherein the solvent is a reactant capable of reacting with the polymer to degrade the polymer into oligomers and at least one monomer;
b) providing a reusable heterogeneous catalyst being capable of degrading the polymer into the oligomers and the at least one monomer;
c) degrading the polymer in the reaction mixture at reaction conditions using the catalyst to form the at least one monomer; and
d) recovering the catalyst from the reaction mixture;
wherein the method further comprises the addition of a salt to the reaction mixture in at least one of the method steps a) to d), wherein the salt has at least one multivalent monoatomic or polyatomic anion.

2. Method as claimed in claim 1, wherein water is added to the reaction mixture prior to or during the recovery of the catalyst in step d).

3. Method as claimed in claim 2, wherein the water is added to the reaction mixture in an amount such that the weight ratio of water to solvent ranges from 0.2 to 5.0, preferably from 0.5 to 1.5, more preferably from 0.7 to 1.3, and even more preferably from 0.9 to 1.1.

4. Method as claimed in claim 1, wherein the amount of catalyst relative to the amount of polymer ranges from 0.001:10 to 1:10, preferably from 0.005:10 to 0.3:10, and more preferably from 0.008 to 0.015:10.

5. Method as claimed in claim 1, wherein the salt is added to the reaction mixture in an amount relative to the amount of catalyst ranging from 0.1:1 to 40:1, preferably from 0.5:1 to 30:1, more preferably from 0.8:1 to 5:1, and most preferably from 0.8:1 to 2:1.

6. Method as claimed in claim 1, wherein the salt comprises at least one of a neutral salt, a basic salt, an acidic salt and a complex salt.

7. Method as claimed in claim 1, wherein the salt is selected from metal sulphates, metal carbonates, metal phosphates and metal citrates.

8. Method as claimed in claim 7, wherein the metal is selected from potassium, sodium, iron, zinc and magnesium.

9. Method as claimed in claim 7 or 8, wherein metal phosphates are excluded.

10. Method as claimed in claim 7, wherein the use of sodium carbonate in the reaction mixture in an amount relative to the amount of catalyst of from 25:1 to 35:1 is excluded.

11. Method as claimed in claim 1, wherein the salt is added in step a) or in step b).

12. Method as claimed in claim 2, wherein the water is added to the reaction mixture prior to the recovery of the catalyst in step d).

13. Method as claimed in claim 1, wherein after the degrading step the reaction mixture is cooled to below 170° C.

14. Method as claimed in claim 2, wherein the addition of water to the reaction mixture prior to or during the recovering of the catalyst in step d) is performed at a temperature below 160° C., preferably below 100° C.

15. Method as claimed in claim 1, wherein the recovering step comprises separating the catalyst from the reaction mixture.

16. Method as claimed in claim 15, wherein the separation step is performed using a centrifuge.

17. Method as claimed in claim 15, wherein the separation step is performed using magnetic separation and/or application of an electric field.

18. Method as claimed in claim 15, wherein the separation is performed at a temperature of between 60° C. and 100° C., preferably of between 75° C. and 95° C.

19. Method as claimed in claim 1, wherein the reusable catalyst comprises a catalyst complex comprising a catalyst entity, a metal containing nanoparticle, and a bridging moiety connecting the catalyst entity to the magnetic nanoparticle, wherein the catalyst entity comprises a cationic moiety having a positive charge, and an anionic moiety, having a negative charge, and preferably providing a negative counterion.

20. Method as claimed in claim 1, wherein a weight ratio of solvent, preferably ethylene glycol, to the polymer is in the range of from 20:10 to 100:10, more preferably from 40:10 to 90:10, and most preferably from 60:10 to 80:10.

21. Method as claimed in claim 1, wherein a polymer concentration in the dispersion is 1-30 wt. % of the total weight of the reaction mixture.

22. Method as claimed in claim 1, wherein the degrading step c) comprises forming the monomer at a temperature higher than 170° C., and preferably at most 250° C., at a pressure higher than 1.0 bar, and preferably lower than 3.0 bar.

23. Method as claimed in claim 1, wherein the recovered catalyst is at least partly used in step b).

24. (canceled)

25. (canceled)

26. (canceled)
